(19) United States
(12) Patent Application Publication
(10) Pub. No.: US 2007/0058273 A1
(43) Pub. Date: Mar. 15, 2007

(54) Driving assist system

(75) Inventors: Takanori Ito, Mie (JP); Hideo Kato, Mie (JP); Masayoshi Imoto, Mie (JP); Takao Kashihara, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 11/519,785

(22) Filed: Sep. 13, 2006

(30) Foreign Application Priority Data
Sep. 15, 2005 (JP) 2005-268632
Apr. 19, 2006 (JP) 2006-115666

(51) Int. Cl. G02B 5/08

(52) U.S. Cl. 359/843

(57) ABSTRACT

A driving assist system is provided with a photographing unit which photographs an image of an area around a periphery of the vehicle, a first storing unit which stores a primary image of the trailer and the vehicle coupled together, the primary image being photographed by the photographing unit in advance, a display unit which displays an image, and an image processing unit which obtains a direction and a distance over which the vehicle has to travel for the trailer to be coupled thereto. The photographing unit photographs an secondary image when coupling the trailer to the vehicle. The image processing unit obtains the direction and the distance based on the primary image and the secondary image, and displays the direction and the distance together with the secondary image on the display unit.

The present invention claims foreign priority from Japanese patent application no. 2005-268632, filed on Sep. 15, 2005 and Japanese patent application no. 2006-115666, filed on Apr. 19, 2006, the contents of which are incorporated herein by reference.

### BACKGROUND OF THE INVENTION

1. Field of the Invention

The present invention relates to a driving assist system, and more particularly to a driving assist system for assisting a driver of a vehicle when coupling a trailer to the vehicle.

2. Description of the Related Art

As a procedure for coupling a trailer to a vehicle (hereinafter, in this specification, a boat trailer will be taken as an example of the trailer), firstly, the vehicle is driven in reverse gear so as to make a hitch member on the vehicle approach a coupler on a boat trailer to some extent. Thereafter, the coupler is coupled to the hitch member by manually moving the boat trailer.

However, in case where the approach of the hitch member to the coupler is insufficient when driving the vehicle in a reverse gear, a distance over which the boat trailer is moved thereafter is increased. Therefore, much labor is required to accomplish the work.

### SUMMARY OF THE INVENTION

It is an object of the present invention to provide a driving assist system which enables the vehicle to approach the trailer to a satisfied extent when coupling the trailer to the vehicle.

According to a first aspect of the invention, there is provided a driving assist system for assisting a driver of a vehicle when coupling a trailer to the vehicle, the driving assist system includes: a photographing unit which photographs an image of an area around a periphery of the vehicle; a first storing unit which stores a primary image of the trailer and the vehicle coupled together, the primary image being photographed by the photographing unit in advance, a display unit which displays an image; and an image-processing unit which obtains a direction and a distance over which the vehicle has to travel for the trailer to be coupled thereto; wherein the photographing unit photographs an secondary image when coupling the trailer to the vehicle, and the image processing unit obtains the direction and the distance based on the primary image and the secondary image, and displays the direction and the distance together with the secondary image on the display unit.

According to a second aspect of the invention, as set forth in the first aspect of the invention, the image processing unit includes: a setting unit which sets a characteristic portion of the trailer within the primary image; an extracting unit which extracts the characteristic portion from the secondary image; and an operating unit which obtains the direction based on a position of the characteristic portion within the primary image and a position of the characteristic portion within the secondary image.

According to a third aspect of the invention, as set forth in the first or the second aspect of the invention, the vehicle is provided with a coupling device which couples the trailer to the vehicle, and the image processing unit displays a virtual graphic form of the coupling device together with the secondary image on the display unit when the coupling device is not included in a photographing range of the photographing unit.

According to a fourth aspect of the invention, as set forth in any of the first to third aspects of the invention, the image processing unit comprises an enlarged display control unit which extracts and enlarges an image area from the secondary image, the image area including a portion of the vehicle where the trailer is to be coupled, and displays an enlarged image of the image area on the display unit.

According to a fifth aspect of the invention, as set forth in the fourth aspect of the invention, the driving assist system further includes a switch which switches a magnification of the enlarged image.

According to a sixth aspect of the invention, as set forth in the fourth or the fifth aspect of the invention, the enlarged display control unit extracts the image area from the secondary image such that the portion of the vehicle is displayed substantially at a horizontal center of the enlarged image.

According to a seventh aspect of the invention, as set forth in any of the fourth to sixth aspects of the invention, the image processing unit further includes: a second storing unit which stores a coordinate transforming table for correcting an image distortion; and a correcting unit which corrects an image distortion of the enlarged image using the coordinate transforming table.

According to the driving assist system as set forth in the first aspect of the invention, the image processing unit obtains the direction in and the distance over which the vehicle has to travel for the trainer to be coupled to the vehicle, and displays the direction and the distance so obtained together with the secondary image on the display unit. Consequently, the driver of the vehicle can drive the vehicle in the direction and over the distance which are displayed on the display means, and can cause the vehicle to approach the trailer to a sufficient extent. As a result, since the distance over which the vehicle has to be moved manually thereafter becomes short, the labor required for the work can be reduced.

According to the driving assist system as set forth in the second aspect of the invention, the image processing unit extracts the characteristic portion that is set by the setting unit from the secondary image, and obtains the distance in which the vehicle has to travel based on the position of the characteristic portion within the primary image and the position of the characteristic portion within the secondary image. Consequently, the direction in which the vehicle has to travel can be obtained easily and securely.

According to the driving assist system as set forth in the third aspect of the invention, even if the coupling device is not included within the photographing range due to a dead angle of the bumper or the like, the virtual graphic form of the coupling device is displayed together with the secondary image on the display unit. Consequently, it will be easy for the driver who watches the display unit to capture a feeling that the trailer is approaching the coupling device as the vehicle moves in the backward direction.

According to the driving assist system as set forth in the fourth aspect of the invention, the enlarged display control unit extracts and enlarges the image area of the secondary image which includes the portion of the vehicle where the trailer is to be coupled, and displays the enlarged image so obtained on the display unit. Consequently, it will be easy for the driver of the vehicle to grasp a relative positional relation between the vehicle and the trailer by referring to the enlarged image of the portion to be coupled.

According to the driving assist system as set forth in the fifth aspect of the invention, the magnification of the enlarged image can be switched to the plurality of stages. Consequently, when a distance between the vehicle and the trailer is long, the driver of the vehicle can confirm widely that the peripheral conditions of the vehicle are safe by selecting a small magnification. In addition, when a distance between the vehicle and the trailer is short, the driver of the vehicle can observe in detail the relative positional relation between the vehicle and the trailer by selecting a large magnification.

According to the driving assist system as set forth in the sixth aspect of the invention, the enlarged display control unit extracts the image area from the secondary image so that the portion of the vehicle is displayed substantially at the horizontal center of the enlarged image. Consequently, even if the portion of the vehicle displayed is deviated from the horizontal center of the screen due to a mounting error of the photographing unit to the vehicle or the like, the enlarged image in which the portion of the vehicle is located at the horizontal center thereof can be displayed.

According to the driving assist system as set forth in the seventh aspect of the invention, the correcting unit corrects the image distortion of the enlarged image using the coordinate transforming table. Consequently, the visibility can be increased when the driver of the vehicle refers to the enlarged image.

### BRIEF DESCRIPTION OF THE DRAWINGS

FIG. 1 is a block diagram showing the configuration of a driving assist system according to a first embodiment of the invention;

FIG. 2 is an exemplary diagram showing a location where a back camera 1 is placed;

FIG. 3 is a diagram showing an image photographed by the back camera 1 and displayed on a display unit 3;

FIG. 4 is a block diagram which specifically shows the configuration of an image processing unit 2;

FIG. 5 is a diagram showing an image displayed by an image signal S0;

FIG. 6 is a diagram which exemplarily shows a coupling portion between a vehicle and a boat trailer 30;

FIG. 7 is a diagram showing an image S1 photographed by the back camera 1;

FIG. 8 is a diagram showing a composite image displayed on the display unit 3;

FIG. 9 is a diagram showing an image which includes a virtual graphic form 80 of a hitch member 10;

FIG. 10 is a block diagram showing the configuration of a driving assist system according to a second embodiment of the invention;

FIG. 11 is a diagram showing a first example of an image S2;

FIG. 12 is a diagram showing a second example of an image S2;

FIG. 13 is a diagram showing a third example of an image S2;

FIG. 14 is a diagram showing a fourth example of an image S2; and

FIG. 15 is a diagram showing a fifth example of an image S2.

### DESCRIPTION OF THE EXEMPLARY EMBODIMENTS

Hereinafter, exemplary embodiments of the invention will be described in detail with reference to the drawings. Note that elements given the same reference numerals in the different drawings are understood to denote the same or corresponding elements.

### First Embodiment

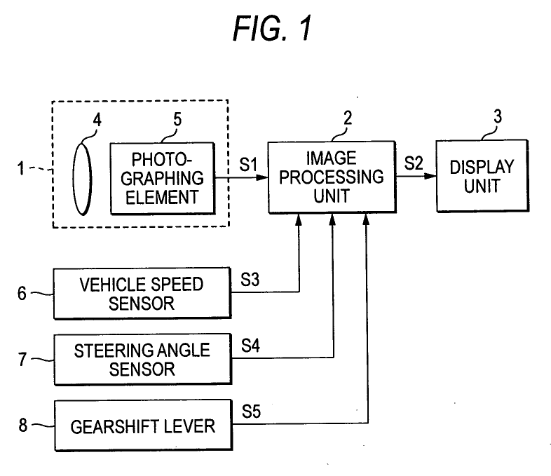

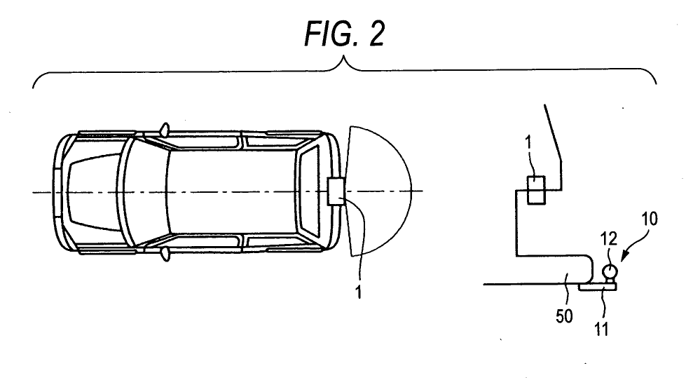

FIG. 1 is a block diagram showing the configuration of a driving assist system according to the first embodiment of the invention. As is shown in FIG. 1, a driving assist system according to the first embodiment has a back camera 1, an image processing unit 2, and a display unit 3. The back camera 1 has a lens system 4 and a photographing element 5 such as CCD. As is shown in FIG. 2, the back camera 1 is provided at a rear end portion of a vehicle and can photograph a rear area behind the vehicle. Referring to FIG. 2, a hitch member 10 for coupling a boat trailer 30, which will be described later on, to the vehicle is mounted underneath a rear bumper 50 of the vehicle. The hitch member 10 has a mount 11 and a hitch ball 12.

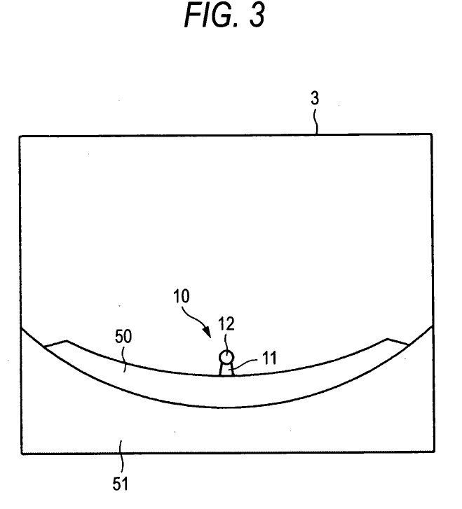

FIG. 3 is a diagram showing an image photographed by the back camera 1 and displayed on the display unit 3 in such a state that the hitch member 10 is mounted on the vehicle. The rear bumper 50, a portion 51 of a body of the vehicle and the hitch member 10 are displayed on the display unit 3. Namely, in an example shown in FIG. 3, the hitch member 10 is included within a photographing range of the back camera 1 without falling into the range of a dead angle of the rear bumper 50.

Referring to FIG. 1, an image signal S1 relating to an image photographed by the back camera 1 is input into the image processing unit 2. An image signal S2 relating to a composite image, which will be described later on, is output from the image processing unit 2. The display unit 3 is made up of a liquid crystal display system, for example, and is provided in a position where the display unit 3 becomes visible to the driver. The image signal S2 is input into the display unit 3, and a composite image prepared by the image processing unit 2 is displayed on a display screen of the display unit 3.

A vehicle speed signal S3 detected by a vehicle speed sensor 6 and a steering angle signal S4 detected by a steering angle sensor 7 are input into the image processing unit 2, and a gearshift signal S5 relating to a current gearshift position of a gearshift lever 8 is also input into the image processing unit 2.

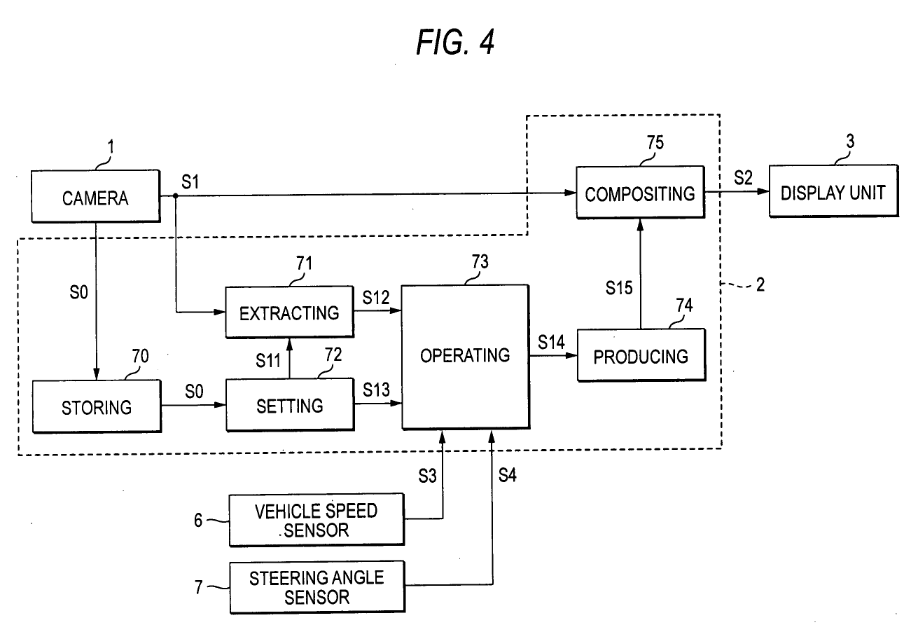

FIG. 4 is a block diagram which specifically shows the configuration of the image processing unit 2 shown in FIG. 1. As is shown in FIG. 4, the image processing unit 2 has an image storing unit 70, an image extracting unit 71, an image setting unit 72, an operating unit 73, an image producing unit 74 and an image compositing unit 75.

In the driving assist system according to the first embodiment, as an initial process, it is necessary that the vehicle and the boat trailer 30 are coupled together in advance and an image of the coupled state is photographed by the back camera 1. An image signal S0 relating to the image photographed in the initial process is input and stored in the image storing unit 70.

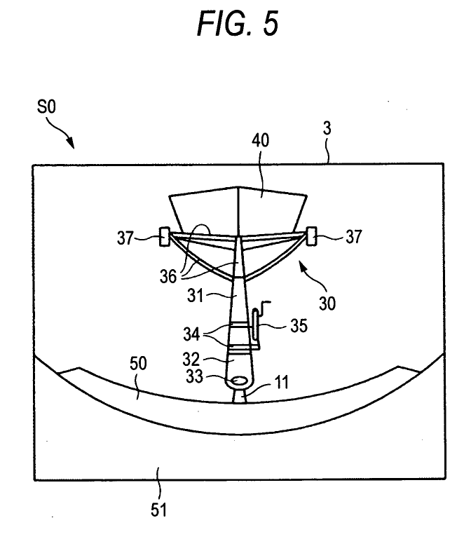

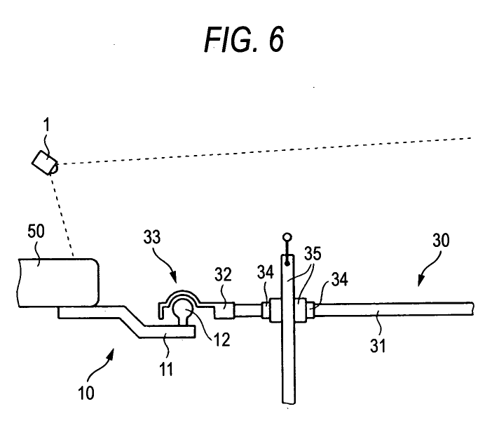

FIG. 5 is a diagram showing an image (hereinafter, also referred to as an “image S0”) presented by the image signal S0. FIG. 6 is a diagram showing exemplarily a coupling portion where the vehicle and the boat trailer 30 are coupled together. Referring to FIGS. 5, 6, a coupler 32 is fixed to a distal end of a tongue frame 31. A semi-spherical portion 33 is formed on the coupler 32, and the coupler 32 and the hitch member 10 are coupled together by placing the semi-spherical portion 33 over the hitch ball 12. In addition, a trailer jack 35 is attached to the tongue frame 31 with a fixing device 34 on the trailer side of the coupler 32. A main frame 36 is fixed to the trailer side of the tongue frame 31, and a boat 40 is placed on the main frame 36. In addition, wheels 37 are provided on sides of the main frame 36.

Referring to FIG. 4, the image signal S0 is input into the image setting unit 72. The image setting unit 72 sets a characteristic portion of the boat trailer 30 from the contents of the image S0. This setting may be implemented automatically by the image setting unit 72 or may be implemented through an instruction by the user. Here, it is assumed that the semi-spherical portion 33 of the coupler 32 is set as a characteristic portion. The image setting unit 72 obtains coordinates of a position of the semi-spherical portion 33 in the image S0, and inputs coordinate data S13 of the coordinates of the position into the operating unit 73. In addition, the image setting unit 72 prepares shape data S11 relating to the shape of the semi-spherical portion 33, and inputs the data so prepared into the image extracting unit 71. Here, it is desirable that the image processing unit 72 prepare a number of template images that are different in the size and visualizing angle of the semi-spherical portion 33, and input image data of the plurality of template images into the image extracting unit 71 as the shape data S11.

Next, a process will be described in which the vehicle and the boat trailer 30 are actually coupled together after completion of the initial process.

Referring to FIG. 1, when the gearshift lever 8 is set in the reverse position in order to drive the vehicle in backward direction, the image processing unit 2 receives a gearshift signal S5 which signals the reversing movement of the vehicle and starts to operate such that the back camera 1 is driven and the display unit 3 is switched so as to display an image photographed by the back camera 1.

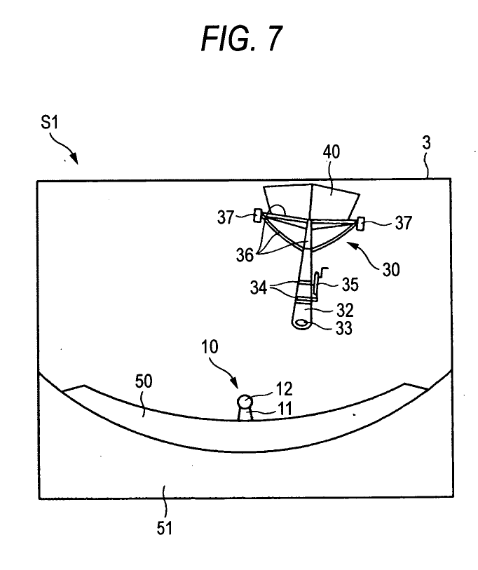

Referring to FIG. 4, an image signal S1 relating to an image photographed by the back camera 1 (see FIG. 7. Hereinafter, also referred to as an “image S1”) is input into the image compositing unit 75 and the image extracting unit 71. The image extracting unit 71 implements a template matching process using the shape data S11 input from the image setting unit 72, so as to extract the semi-spherical portion 33 of the boat trailer 30 from the contents of the image S1. The image extracting unit 71 obtains coordinates of the position of the semi-spherical portion 33 within the image S1 and inputs coordinate data S12 relating to the coordinates of the position of the semi-spherical portion 33 into the operating unit 73.

The operating unit 73 compares coordinate data S13 input from the image setting unit 72 with the coordinate data S12 input from the image extracting unit 71 to thereby obtain a direction in which the vehicle has to travel in order to cause the coordinates of the position of the semi-spherical portion 33 in the image S1 to coincide with the coordinates of the position of the semi-spherical portion 33 in the image S0 (namely, the direction in which the vehicle has to travel in order to cause the boat trailer 30 to be coupled to the vehicle) However, a direction in which the steering wheel has to be turned may be obtained instead of the direction in which the vehicle has to travel.

In addition, as is described in Japanese Patent Application No. 2005-71689 filed by the applicants of the present patent application, the operating unit 73 may calculate a distance from the current vehicle position to the semi-spherical portion 33 based on coordinates of the positions of the semi-spherical portion 33, each set within a plurality of images S1 that are obtained at different points of time, a traveling distance of the vehicle that is obtained from a vehicle speed signal S3 input from the vehicle sensor 6, and a steering angle signal S4 input from the steering angle sensor 7. However, distance from the vehicle to the semi-spherical portion 33 may be measured by a distance measuring sensor instead of obtaining the distance to the semi-spherical portion 33 by image processing.

The operating unit 73 inputs the data relating to the travel in which the vehicle has to travel and the data relating to the distance from the vehicle to the semi-spherical portion 33 into the image producing unit 74 as direction and distance data S14. Based on the direction and distance data S14, the image producing unit 74 prepares a first partial image 45 which shows the direction in which the vehicle has to travel by an arrow and a second partial image 46 which shows the distance from the vehicle to the semi-spherical portion 33, and inputs an image signal S15 relating to the first and second partial images 45, 46 into the image compositing unit 75.

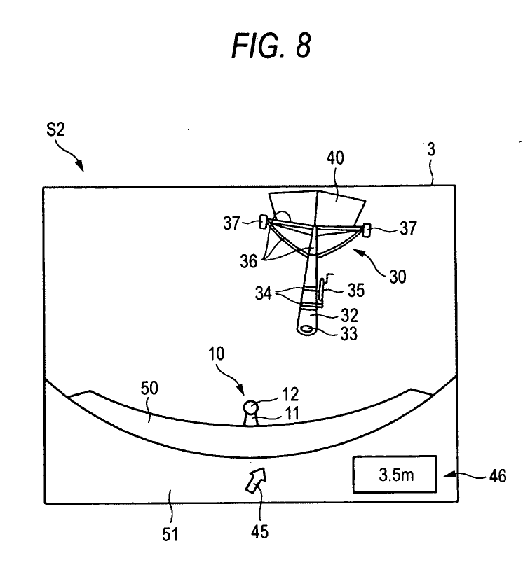

The image compositing unit 75 combines the image signal S1 input from the back camera 1 and the image signal S15 input from the image producing unit 74 together to thereby produce an image signal S2 which signals a composite image shown in FIG. 8. Referring to FIG. 8, the composite image presented by the image signal S2 is such that the first and second partial images 45, 46 are added to the image S1 shown in FIG. 7. The image signal S2 is input into the display unit 3, whereby the image shown in FIG. 8 is displayed on the display screen of the display unit 3.

### MODIFIED EXAMPLE

In the first embodiment that is described above, the explanation is made on an assumption that the hitch member 10 does not fall in the range of the dead angle of the rear bumper 50, and is included within the photographing range of the back camera 1. However, depending on models of the vehicle and shapes of the hitch member 10, there may be a case where the hitch member 10 falls within the range of the dead angle of the rear bumper 50, and is not included in the photographing range of the back camera 1.

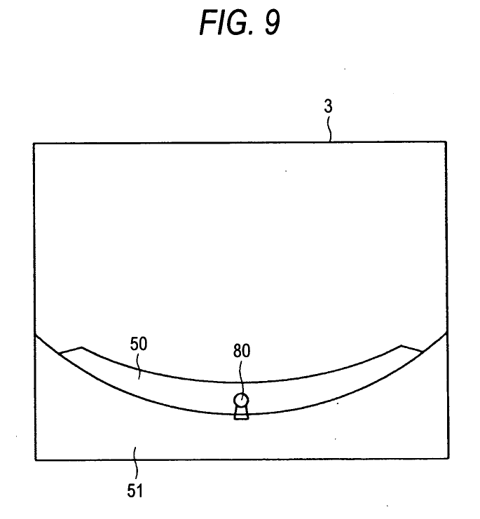

In such a case, a virtual graphic form 80 which represents exemplarily the shape of the hitch member 10 may be displayed on the display unit 3 such that the virtual graphic form 80 overlaps with the rear bumper 50, as is shown in FIG. 9. It is desirable that the virtual graphic form 80 is displayed at a location in the display unit 3 where the hitch member 10 is actually situated, assuming that the hitch member 10 is seen from the back camera 1 through the rear bumper 50.

The driver who watches the display unit 3 can easily grasp the sensation that the boat trailer 30 is approaching the hitch member 10 as the vehicle moves in the backward direction by displaying the virtual graphic form 80 of the hitch member 10 on the display unit 3.

Also, when the hitch member 10 falls within the range of the dead angle of the rear bumper 50, the fixing device 34 or the trailer jack 35, which do not fall within the range of the dead angle, may be set as the characteristic portion of the boat trailer 30 instead of setting the semi-spherical portion 33 of the boat trailer 30 as the characteristic portion.

Thus, according to the driving assist system of the first embodiment, the operating unit 73 obtains the direction and the distance over which the vehicle has to travel in order to cause the boat trailer 30 to be coupled to the vehicle, combines the first and second partial images 45, 46 relating to the direction and distance so obtained with the image S1, and displays the composite image on the display unit 3. Consequently, the driver of the vehicle drives the vehicle so as to travel in accordance with the direction and distance displayed on the display unit 3, whereby the vehicle can be caused to approach the boat trailer 30 to a sufficient extent. As a result, since a distance over which the boat trailer 30 has to be moved manually becomes short, the labor for the work can be reduced.

In addition, the image extracting unit 71 extracts the characteristic portion set by the image setting unit 72 (the semi-spherical portion 33 in the examples described above) from the image S1, and the operating unit 73 obtains the direction in which the vehicle has to travel based on the coordinates of the position of the characteristic portion within the image S0 and the coordinates of the position of the characteristic portion within the image S1. Consequently, the direction in which the vehicle has to travel can be obtained easily and securely.

### Second Embodiment

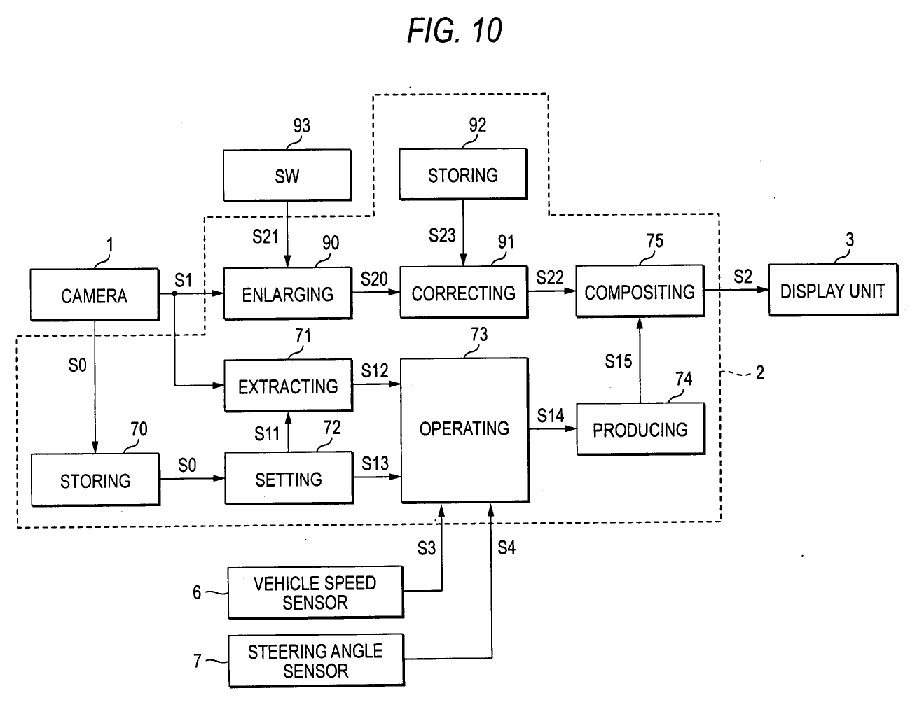

FIG. 10 is a block diagram showing the configuration of a driving assist system according to the second embodiment of the invention. The driving assist system according to the second embodiment is configured such that an image enlarging unit (enlarged display control means) 90, a distortion correcting unit 91, a switch 93 and a storing unit 92 are added on the basis of the driving assist system according to the first embodiment as shown in FIG. 4. The image enlarging unit 90, the distortion correcting unit 91 and the storing unit 92 are provided within the image processing unit 2. The switch 93 is provided in a position where the driver of the vehicle can operate the switch easily.

Since the operations of an image storing unit 70, an image extracting unit 71, an image setting unit 72, an operating unit 73 and an image compositing unit 74 are similar to those of the first embodiment, the description thereof will be omitted here.

An image S1 photographed by a back camera 1 is input into the image enlarging unit 90. The image enlarging unit 90 extracts an image area from the image S1, the image area including a portion (the hitch member 10 in this example) of the vehicle that is to be coupled to the boat trailer 30, and produces an image signal S20 which signals an enlarged image. The magnification of the enlarged image can be switched to a plurality of stages by virtue of the operation of the switch 93 by the driver. Namely, a signal S21 which signals a magnification is input from the switch 93 to the image enlarging unit 90, and the image enlarging unit 90 changes magnifications based on the signal S21.

The image signal S20 relating to the enlarged image is input into the distortion correcting unit 91. In addition, a coordinate transforming table for correcting an image distortion is prepared in advance and is stored in the storing unit 92. A corresponding relation in coordinate transformation between a photographed image and a displayed image is set in the coordinate transforming table such that, when a board on which a lattice pattern is drawn is photographed by the back camera and is then displayed on a display unit 3 for example, an image distortion attributed to the lens properties is eliminated so as to enable the lattice pattern to be reproduced properly also on a displayed image. Data S23 relating to the coordinate transforming table is input into the distortion correcting unit 91.

The distortion correcting unit 91 processes (coordinate transforms) the enlarged image presented by the image signal S20 based on the coordinate transforming table to thereby correct an image distortion. An image signal S22 which signals an enlarged image in which the image distortion has been corrected is input into the image compositing unit 75.

The image compositing unit 75 combines the enlarged image presented by the image signal S22 with the image signal S15 input from the image producing unit 74 to thereby produce an image signal S2 which signals a composite image. The image signal S2 is input into the display unit 3, and the composite image is then displayed on the display screen of the display unit 3.

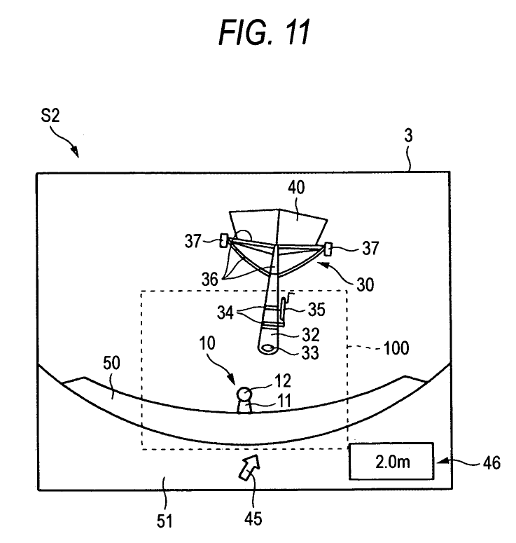

FIG. 11 is a diagram showing a first example of the image (hereinafter, also referred to as an “image S2”) presented by the image signal S2. FIG. 11 shows an example in which the magnification that is specified by the signal S21 is “1.” A different point from the image S2 shown in FIG. 8 is that the distance between the vehicle and the boat trailer 30 is reduced from 3.5 mm to 2.0 mm.

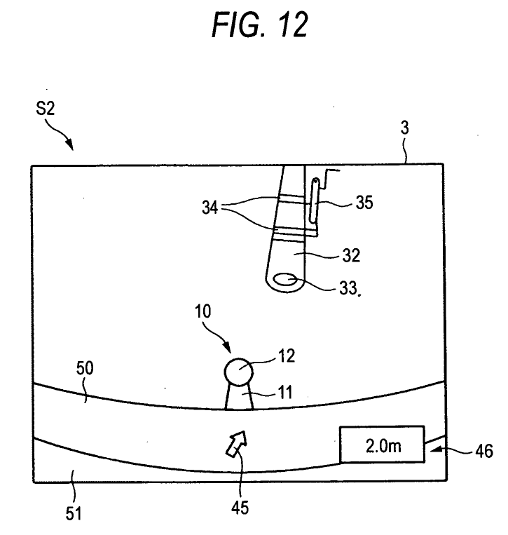

FIG. 12 is a diagram showing a second example of the image S2. FIG. 12 shows an example in which the magnification that is specified by the signal S21 is α (>1). An image area 100 within the image S2 shown in FIG. 11 is enlarged to correspond to an image displayed on the whole screen of the display unit 3.

The image area 100 is specified within the image S1 by the following process. Firstly, the hitch member 10 which constitutes the portion of the vehicle that is to be coupled to the boat trailer 30 is designated. Then, a template image relating to the shape of the hitch member 10 is prepared, and stored in a storing unit (not shown) which can be referred to by the image enlarging unit 90. The image enlarging unit 90 implements a template matching process to thereby extract the position of the hitch member 10 from the contents of the image S1. Then, the image area 100 is specified within the image S1 according to a designated magnification so that the hitch member 10 is located at a specific location (slightly below the center) within the image area 100.

Here, the position in the image S1 where the hitch member 10 is located can be restricted to some extent by the image angle and mounting angle of the back camera 1 at a stage when the back camera 1 is mounted on the vehicle. Consequently, a range where the hitch member 10 is searched for during the template matching process can be limited to an area (for example, a lower half) of the image S1, thereby making it possible to reduce the load of the process.

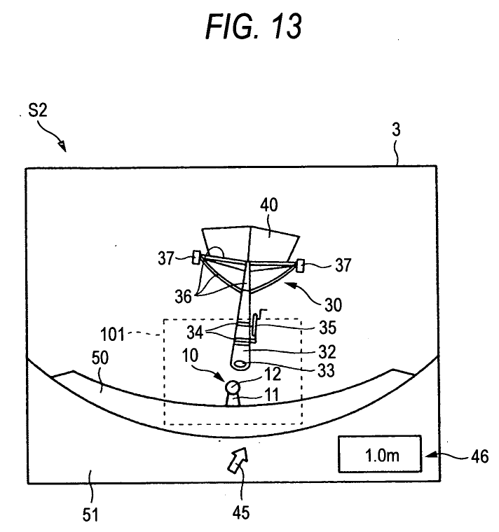

FIG. 13 is a diagram showing a third example of the image S2. FIG. 13 shows an example in which the magnification specified by the signal S21 is “1.” A different point from the image S2 shown in FIG. 11 is that the distance between the vehicle and the boat trailer 30 is reduced from 2.0 m to 1.0 m.

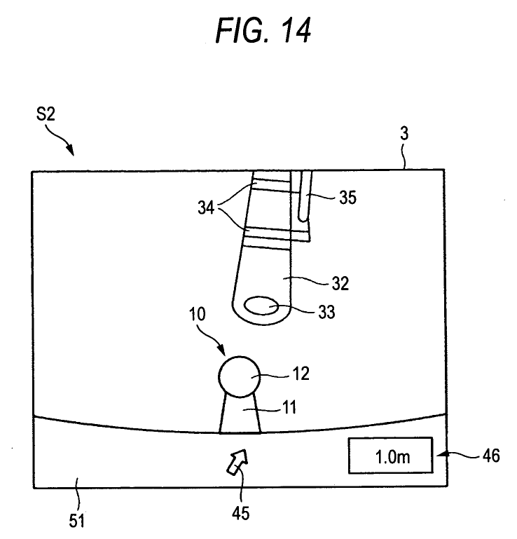

FIG. 14 is a diagram showing a fourth example of the image S2. FIG. 14 shows an example in which the magnification that is specified by the signal S21 is β (>α). An image area 101 within the image S2 shown in FIG. 13 is enlarged to correspond to an image displayed on the whole screen of the display unit 3. The image area 101 can be specified within the image S1 by the same process as that used for the image area 100.

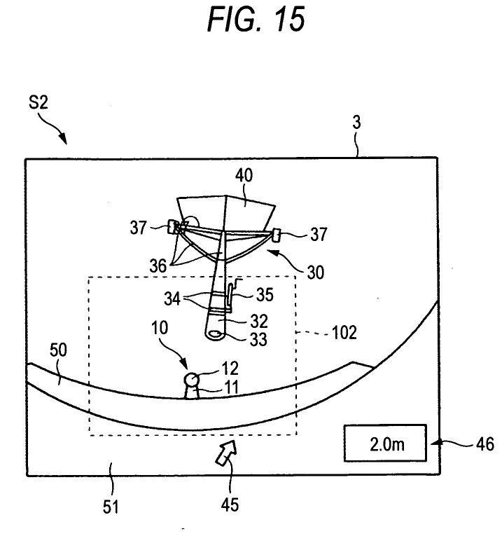

FIG. 15 is a diagram showing a fifth example of the image S2. While the hitch member 10 is located substantially at the center in the horizontal direction (the lateral direction) in FIG. 11, a position where the hitch member 10 is displayed is slightly deviated from a horizontal center due to the mounting position of the back camera 1 on to the vehicle in FIG. 15. Even in such a case, since an image area 102 is specified so that the hitch member 10 is located slightly below the center of the image area 102, an enlarged image corresponding to the image area 102 is displayed on the display unit 3 in the same form as shown in FIG. 12.

According to the driving assist system of the second embodiment, the image enlarging unit 90 extracts and enlarges the image area 100 to 102 of the image S1 which includes the hitch member 10, and the enlarged image so obtained is displayed on the display unit 3. Consequently, the driver of the vehicle can refer to the enlarged image of the coupling portion between the vehicle and the boat trailer 30 to thereby easily grasp the relative positional relation between the vehicle and the boat trailer 30.

In addition, the magnification of the enlarged image can be switched to the plurality of stages through selection using the switch 93. Consequently, when the distance between the vehicle and the boat trailer 30 is long, the driver of the vehicle can confirm safe conditions surrounding the vehicle in a wide range by selecting a small magnification. In contrast, when the distance between the vehicle and the boat trailer 30 is short, the driver of the vehicle can observe in detail the relative positional relation between the vehicle and the boat trailer 30 by selecting a large magnification.

In addition, the image enlarging unit 90 extracts the image area 100 to 102 from the image S1 such that the hitch member 10 is displayed at the substantially horizontal center of the enlarged image. Consequently, even if the hitch member 10 displayed is deviated from the horizontal center of the screen due to the mounting error of the back camera 1 onto the vehicle, the enlarged image can be displayed in which the hitch member 10 is located at the horizontal center, whereby an uncomfortable sensation which is felt by the driver when the hitch member 10 displayed is deviated from the horizontal center of the screen can be eliminated.

In addition, the distortion correcting unit 91 corrects the image distortion of the enlarged image using the coordinate transforming table. Consequently, the visibility when the driver of the vehicle refers to the enlarged image can be increased.

Note that the back camera 1 has been described in the first and second exemplary embodiments, the invention can also be applied to a front camera or a side camera.

In addition, while the boat trailer 30 has been described in the first and second exemplary embodiments, the invention can also be applied to other trailers such as a camping car.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A driving assist system for assisting a driver of a vehicle when coupling a trailer to the vehicle, the driving assist system comprising:
a photographing unit which photographs an image of an area around a periphery of the vehicle;
a first storing unit which stores a primary image of the trailer and the vehicle coupled together, the primary image being photographed by the photographing unit in advance;
a display unit which displays an image; and
an image processing unit which obtains a direction and a distance over which the vehicle has to travel for the trailer to be coupled thereto,
wherein the photographing unit photographs an secondary image when coupling the trailer to the vehicle, and
the image processing unit obtains the direction and the distance based on the primary image and the secondary image, and displays the direction and the distance together with the secondary image on the display unit.

2. The driving assist system according to claim 1, wherein the image processing unit comprises:
a setting unit which sets a characteristic portion of the trailer within the primary image;
an extracting unit which extracts the characteristic portion from the secondary image; and
an operating unit which obtains the direction based on a position of the characteristic portion within the primary image and a position of the characteristic portion within the secondary image.

3. The driving assist system according to claim 1, wherein the vehicle is provided with a coupling device which couples the trailer to the vehicle, and the image processing unit displays a virtual graphic form of the coupling device together with the secondary image on the display unit when the coupling device is not included in a photographing range of the photographing unit.

4. The driving assist system according to claim 1, wherein the image processing unit comprises an enlarged display control unit which extracts and enlarges an image area from the secondary image, the image area including a portion of the vehicle where the trailer is to be coupled, and displays an enlarged image of the image area on the display unit.

5. The driving assist system according to claim 4, further comprising a switch which switches a magnification of the enlarged image.

6. The driving assist system according to claim 4, wherein the enlarged display control unit extracts the image area from the secondary image such that the portion of the vehicle is displayed substantially at a horizontal center of the enlarged image.

7. The driving assist system according to claim 4, wherein the image processing unit further comprises:
a second storing unit which stores a coordinate transforming table for correcting an image distortion; and
a correcting unit which corrects an image distortion of the enlarged image using the coordinate transforming table.

8. The driving assist system according to claim 2, wherein the vehicle is provided with a coupling device which couples the trailer to the vehicle, and the image processing unit displays a virtual graphic form of the coupling device together with the secondary image on the display unit when the coupling device is not included in a photographing range of the photographing unit.

9. The driving assist system according to claim 2, wherein the image processing unit further comprises an enlarged display control unit which extracts and enlarges an image area from the secondary image, the image area including a portion of the vehicle where the trailer is to be coupled, and displays an enlarged image of the image area on the display unit.

10. The driving assist system according to claim 3, wherein the image processing unit comprises an enlarged display control unit which extracts and enlarges an image area from the secondary image, the image area including a portion of the vehicle where the trailer is to be coupled, and displays an enlarged image of the image area on the display unit.

11. The driving assist system according to claim 8, wherein the image processing unit further comprises an enlarged display control unit which extracts and enlarges an image area from the secondary image, the image area including a portion of the vehicle where the trailer is to be coupled, and displays an enlarged image of the image area on the display unit.

12. The driving assist system according to claim 1, further comprising:
a vehicle speed sensor; and
a steering angle sensor,
wherein the image processing unit obtains the direction and the distance based on the vehicle speed signal input from the vehicle speed sensor and the steering angle signal input from the steering angle sensor.

13. The driving assist system according to claim 1, wherein the image processing unit comprises:
an image producing unit which prepares a first partial image which shows the direction and a second partial image which shows the distance; and
an image compositing unit which combines the first partial image and the second partial image with the secondary image.
